(19) United States
(12) Patent Application Publication
(10) Pub. No.: US 2026/0171729 A1
(43) Pub. Date: Jun. 18, 2026

(54) ELECTRICAL CONNECTOR

(71) Applicant: V-General Technology Co., Ltd., New Taipei City (TW)

(72) Inventors: Po-Wen YEH, New Taipei City (TW); Tzu-Wei YEH, New Taipei City (TW); Yu-Lun YEH, New Taipei City (TW); Chien-Yeh LEE, New Taipei City (TW)

(21) Appl. No.: 18/983,307

(22) Filed: Dec. 16, 2024

(51) Int. Cl. H01R 13/6596; H01R 12/57; H01R 13/6595

(52) U.S. Cl. CPC H01R 13/6596; H01R 12/57; H01R 13/6595

(57) ABSTRACT

An electrical connector includes a shielding housing, at least one external contact element, an elastic portion, a base portion, a contact portion, an insulation plastic body assembly, a tongue portion, an insertion space, a transmission conductor group, a contact section group, a base section group, and a soldering section group. The external contact element is primarily for contacting an electronic component located outside the shielding housing and exhibiting an electrical conducting property. Through the arrangement of the external contact element, the electrical connector is provided with additional noise draining path to improve the performance of draining and effectively reduced electromagnetic interference, radio frequency interference and also to optimize the high-frequency characteristics. Further, the external contact element includes the elastic portion, so that re-assembling can be performed even when errors occur during the course of assembling. The contact impedance of the external contact element can also be reduced.

### BACKGROUND OF THE INVENTION

### (a) Technical Field of the Invention

The present invention relates to an electrical connector, which enhances a noise draining function so as to effectively reduce electromagnetic interference (EMI), radio frequency interference (RFI), and contact impedance of external contact components, and optimize high-frequency characteristics, and not only allow for repeating the assembly process, but also ensure a good contact effect with respect to an external contact component and an increase of draining of noise to the outside.

### (b) Description of the Prior Art

USB transmission line is currently the mainstream and quite popular signal transmission line specification of which connectors have many different types, such as Type A, Type B and Type C. Type C has various advantages of being pluggable either forward or reversely, a transmission rate of up to 10Gbit/s, power supply performance of up to 100W, and being able to replace the 3.5mm audio jack, so that the popularity of USB C type is obviously unstoppable.

However, the use of the USB Type C and Type A still suffer certain problems as follows, which should be further improved.

Because USB Type C can support transfer rates up to 10Gbit/s, it is prone to various noise interferences, such as electromagnetic interference (EMI) and radio frequency interference (RFI). Although optimization engineering has been carried out to handle the interferences, the capability of draining noises is poor, making the overall effect not significant, and the noise interference is still serious. In addition, general electrical connectors are fixed with external electronic components by means of for example screw fastening to form an additional channel for noise draining by way of hard contact. One of the most serious problems with this arrangement is that when an electrical connector is assembled incorrectly and it is necessary to reassemble, a user must use tools to remove the screws, and this is a cumbersome process. Further, even if the function of enhancing noise draining is actually achieved, because it is based on hard contact, there will be problems with respect to inaccurate contact during reassembly, thereby deteriorating the function of noise draining. In addition, USB Type A also suffers interference problems, of which the main reason is that the degree of noise draining is not good. Even though there were efforts made on the shielding housing to alleviate the noise draining problems, the design is mainly based on hard contact, and it makes reassembling impossible and the contact effect is poor.

### SUMMARY OF THE INVENTION

The primary objective of the present invention is to provide an electrical connector, which enhances a noise draining function so as to effectively reduce electromagnetic interference (EMI), radio frequency interference (RFI), and contact impedance of external contact components, and optimize high-frequency characteristics, and not only allow for repeating the assembly process, but also ensure a good contact effect with respect to an external contact component and an increase of draining of noise to the outside.

A structure that the present invention adopts to achieve the above primary objective comprises a shielding housing, which includes at least one external contact element formed on at least one side thereof for contact engagement with an electronic component that is located outside of the shielding housing and exhibits an electrical conducting property. The external contact element includes an elastic portion extending from the shielding housing, a base portion integrally formed on and extending from an end of the elastic portion, and a contact portion integrally formed on and extending from one end of the base portion that is opposite to the elastic portion. Further, an insulation plastic body assembly is received in the shielding housing, and the insulation plastic body assembly comprises a tongue portion. An insertion space is defined between a circumference of the tongue portion and an inside wall of the shielding housing for receiving insertion of a male connector therein. Further, a transmission conductor group that complies with USB Type C transmission protocol or USB Type A transmission protocol is arrange don the insulation plastic body assembly. The transmission conductor group comprises a contact section group arranged on the tongue portion, a base section group formed on and extending from one end of the contact section group, and a soldering section group formed on and extending from one end of the base section group that is opposite to the contact section group, and the soldering section group is arranged as a single row.

When position shifting problems resulting from the mounting position of the electrical connector being incorrect and other faults occur during a course of mounting, as the external contact element comprises the elastic portion, reassembling of the electrical connector is allowed to carry out for overcoming the errors occurring in the course of mounting, without making reassembling impossible as being influenced by the external contact element, and an excellent effect of contact for the external contact element can be ensured. Further, after the mounting of the electrical connector is completely implemented, the external contact element is set, actively or passively, in contact engagement with the electronic component, so as to provide the electrical connector with more paths for draining noises thereby enhancing the performance of draining and effectively reducing electromagnetic interference, radio frequency interference, and contact impedance of the external contact element, and also optimizing the high-frequency characteristics.

Through the above technology, the problems of the existing USB Type C that USB Type C, due to being capable of supporting a transmission rate of up to 10Gbit/s, can easily generate various noise interference, such as electromagnetic interference (EMI) and radio frequency interference (RFI) can be overcome. Although optimization engineering has been commercial conducted for the aforementioned interference, the performance of noise draining is not good, so that the overall effect is not significant and the noise interference is still serious. In addition, general electrical connectors are fixed with external electronic components, such as by means of screw fastening, so that hard contact is achieved for forming a channel to increase noise draining. However, the most serious problem with such an arrangement is that when the electrical connector is assembled incorrectly and needs to be reassembled, a user must use tools to remove the screws. The removal process is cumbersome. Even if it has the function of increasing noise draining, it is hard contact, which will cause inaccurate contact during reassembly, thereby reducing the noise draining performance. In addition, USB Type A also suffers such an interference problem, which is mainly caused by poor noise draining. Even though the noise draining problem has been improved on the shielding housing, the hard contact-based design makes it impossible for reassembling, and the contact effect is poor. The present invention is made to overcome the problems and achieves the practical progress of the above-mentioned advantages of the present invention.

### BRIEF DESCRIPTION OF THE DRAWINGS

FIG. 1 is a perspective view showing a first preferred embodiment of the present invention.

FIG. 2 is an exploded view showing the first preferred embodiment of the present invention.

FIG. 3 is a schematic view showing implementation of the first embodiment of the present invention.

FIG. 4 is a perspective view showing a second preferred embodiment of the present invention.

FIG. 5 is a schematic view showing implementation of the second embodiment of the present invention.

FIG. 6 is a perspective see-through view showing a third preferred embodiment of the present invention.

FIG. 7 is a schematic view showing implementation of the third embodiment of the present invention.

FIG. 8 is a schematic view showing implementation of a fourth embodiment of the present invention.

FIG. 9 is a schematic view showing implementation of a fifth embodiment of the present invention.

### DETAILED DESCRIPTION OF THE PREFERRED EMBODIMENTS

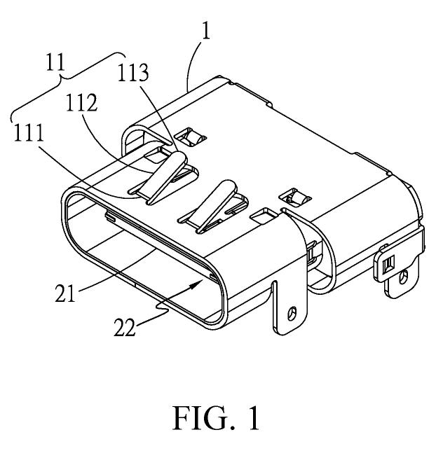

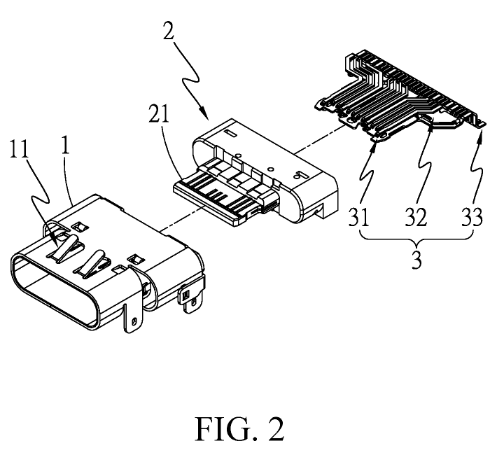

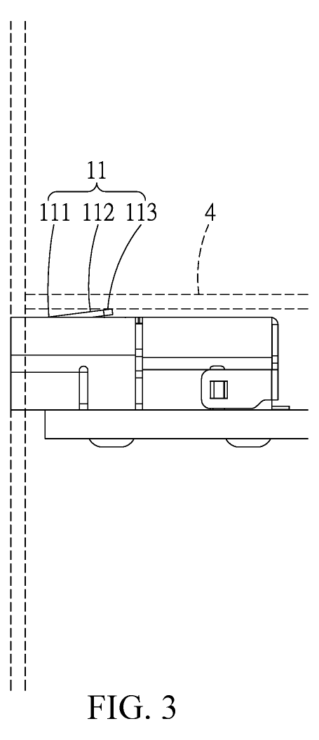

Referring to FIGS. 1-3, which are respectively a perspective view, an exploded view, and a schematic view showing implementation of a first preferred embodiment of the present invention, the drawings clearly show that an electrical connector according to the present invention comprises: a shielding housing 1, which includes at least one external contact element 11 formed on at least one side thereof for contact engagement with an electronic component 4 that is located outside of the shielding housing 1 and exhibits an electrical conducting property, wherein the external contact element 11 comprises an elastic portion 111 extending from the shielding housing 1, a base portion 112 formed on an end of the elastic portion 111 in an extension direction, and a contact portion 113 formed on the base portion 112 in the extension direction; an insulation plastic body assembly 2, which is received in the shielding housing 1 and comprises a tongue portion 21, wherein an insertion space 22 is defined between a circumference of the tongue portion 21 and an inside wall of the shielding housing 1 for receiving insertion of a male connector therein; and a transmission conductor group 3, which is combined with the insulation plastic body assembly 2 and complies with USB Type C transmission protocol or USB Type A transmission protocol, and comprises a contact section group 31 arranged on the tongue portion 21, a base section group 32 formed on and extending from one end of the contact section group 31, and a soldering section group 33 formed on and extending from one end of the base section group 32 that is opposite to the contact section group 31, wherein the soldering section group 33 is arranged as a single row.

In the above, the elastic portion 111 is formed by extending toward outside of the shielding housing 1.

In the above, the elastic portion 111 is adjacent to an open side of the shielding housing 1.

In the above, as an example of illustration, the soldering section group 33 includes 26 soldering pins in the instant embodiment.

In the above, an equipment metal enclosure is taken as an example for illustrating the electronic component 4 in the instant embodiment. Of course, the electronic component 4 can also be one of for example a conductive aluminum foil, a copper foil, a polyester film, conductive foam, a metal baffle, and a metal shielding.

In the above, two external contact elements 11 are taken as an example for illustration in the instant embodiment. Of course, there can be just a single one or more, and this is just a variation in quantity.

When the electrical connector is mounted in the electronic component 4, in case that the mounting position is in correct due to human or other factors, the electrical connector can be re-mounted. This is because that through the arrangement of the elastic portion 111 of the external contact element 11, the present invention possesses a function of elasticity, which forms soft contact when put in contact engagement with the electronic component 4. In other words, even if the external contact element 11 is compressed by the electronic component 4 to cause deformation of the external contact element 11, due to the external contact element 11 itself possesses elasticity, when the electrical connector is removed away from the electronic component 4, the external contact element 11 is capable of resuming the original shape that enables contact engagement with the electronic component 4 in the next mounting operation. Compared with the hard contact adopted in the prior art, the present invention takes means of soft contact to enable repeated mounting of the electrical connector without causing improper contact between the external contact element 11 and the electronic component 4, ensuing that the external contact element 11 possesses an effect of excellent contact engagement, to thereby effectively and stably maintain a noise draining channel and thus enhancing the performance of draining and also extending the service life, and making it possible to enhance the draining path without use of tools or screw elements, and therefore, making it extremely convenient as a whole.

Further, when the electrical connector is completely mounted inside the electronic component 4, the electronic component 4 is in contact engagement with and compresses the external contact element 11 inwards, so as to cause deformation of the elastic portion 111, which, together with the base portion 112, provides an effect of elastic supporting, making the contact portion 113 in firm contact engagement with the electronic component 4 when compressed by the electronic component 4, without separating therefrom, thereby achieving an increase of grounding path to enhance the function of noise draining. This will effectively reduce electromagnetic interference (EMI), radio frequency interference (RFI), and contact impedance of external contact components, and optimizing high-frequency characteristics.

Further, in the instant embodiment, USB Type C is taken as an example for illustrating the transmission conductor group 3 of the electrical connector, but USB Type A can alternatively be adopted, both types being in the scope of protection of the present invention. Further, the electrical connector of the present invention complies with USB Type C transmission protocol and is arranged as a female component and thus may help alleviate the noise draining problems of USB Type C female electrical connectors. In addition, in the present invention, the soldering section group 33 is arranged as a single row, and such an arrangement helps increase the speed of factory operation to improve industrial competition power.

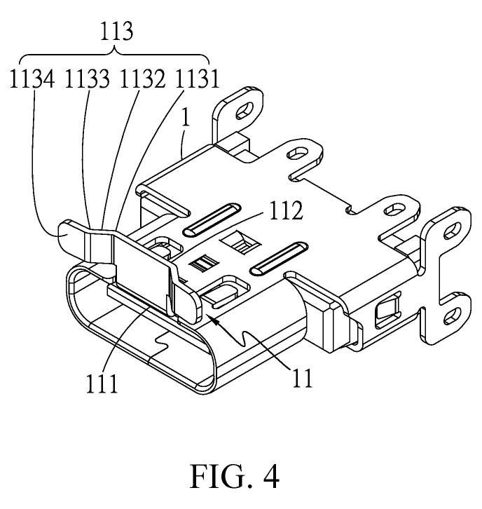

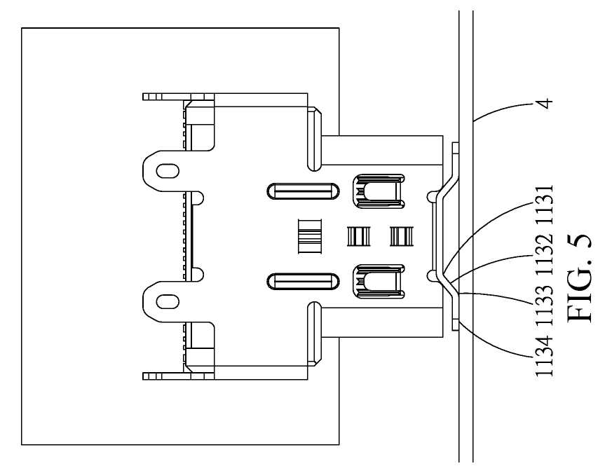

Referring to FIGS. 4 and 5, which are respectively a perspective view and a schematic view showing implementation of a second preferred embodiment of the present invention, the drawings clearly show that in the instant embodiment, the contact portion 113 comprises a first elastic curved portion 1131 connected to the base portion 112, an inclined wall portion 1132 formed on one end of the first elastic curved portion 1131 in the extension direction, a second elastic curved portion 1133 formed on one side of the inclined wall portion 1132 that is opposite to the first elastic curved portion 1131, and an engaging portion 1134 formed on one side of the second elastic curved portion 1133 that is opposite to the inclined wall portion 1132, and the elastic portion 111 is formed by curving in a longitudinal direction and extending from an edge of the open side of the shielding housing 1, so that when the external contact element 11 of the electrical connector is put in contact engagement with the electronic component 4, the electronic component 4 compresses the engaging portion 1134 to make the second elastic curved portion 1133 and the first elastic curved portion 1131 deformed and the inclined wall portion 1132 displaced. As such, the external contact element 11 is formed as an external contact element 11 of elasticity and makes contact with the electronic component 4 by means of soft contact, so that the electrical connector is allowed for repeating operation of mounting and exhibits an advantage of secure and sound contact engagement, and other advantages as those described above, for which repeated description will be omitted herein. Of course, although a single one external contact element 11 is taken as an example for illustration in the instant embodiment, two such contact elements may be used and they can be respectively arranged on an upper side and a lower side of the opening to increases the number of paths for noise draining, achieving a bettered function of noise draining.

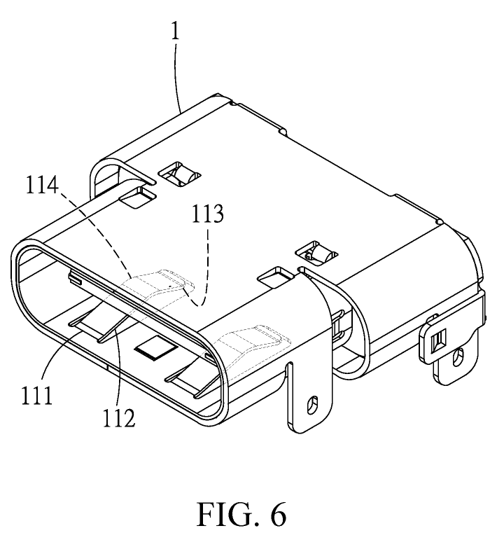

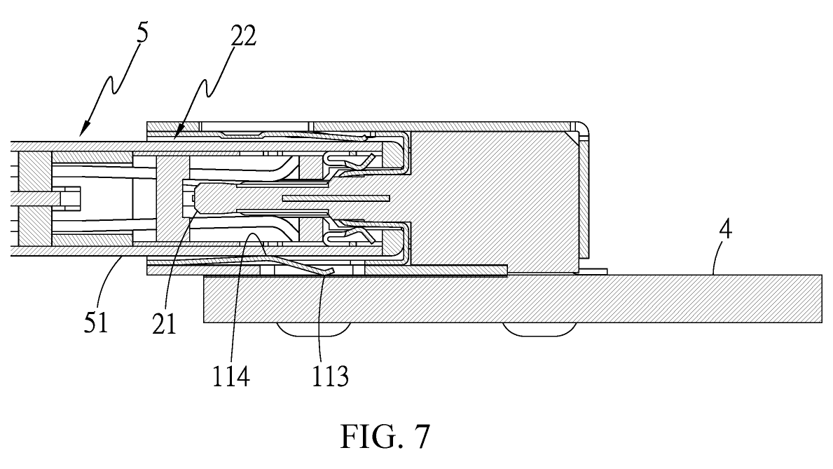

Referring to FIGS. 6 and 7, which are respectively a perspective view and a schematic view showing implementation of a third preferred embodiment of the present invention, the drawings clearly show that in the instant embodiment, the elastic portion 111 is formed by extending toward inside of the shielding housing 1, and an engaging and supporting portion 114 is arranged between the base portion 112 and the contact portion 113 for contact and engagement with a male connector 5, so that the male connector 5 contacting and engaging the engaging and supporting portion 114 makes the elastic portion 111 deformed to bring the contact portion 113 into contact engagement with the electronic component 4. Further, the base portion 112 is formed by extending, in an oblique way, away from the open side of the shielding housing 1. As an example of illustration in the instant embodiment, the electronic component 4 is taken as a conductor region of a circuit board. As such, when the male connector 5 is inserted into the electrical connector of the present invention, a male shielding housing 51 of the male connector 5 is put into the insertion space 22 and encloses the tongue portion 21, meanwhile, at the same time, the male shielding housing 51 is set in contact engagement with the engaging and supporting portion 114 to thereby push the contact portion 113 in a direction from the inside of the shielding housing 1 to the outside, bringing the contact portion 113 into contact with the electronic component 4 to achieve an advantage of enhancing noise draining.

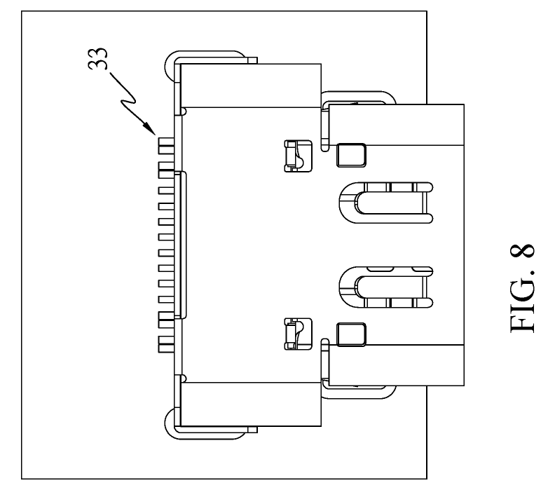

Referring to FIG. 8, which is a schematic view showing implementation of a fourth preferred embodiment of the present invention, the drawing clearly shows that in the instant embodiment, in addition to being arranged in a single row, the number of the soldering pins of the soldering section group 33 is 16, implying the number of the soldering pins is the present invention can be 16 or more, such as 26 in the previous embodiments. Thus, the present invention is applicable to USB Type C electrical connector having more than 16 pins.

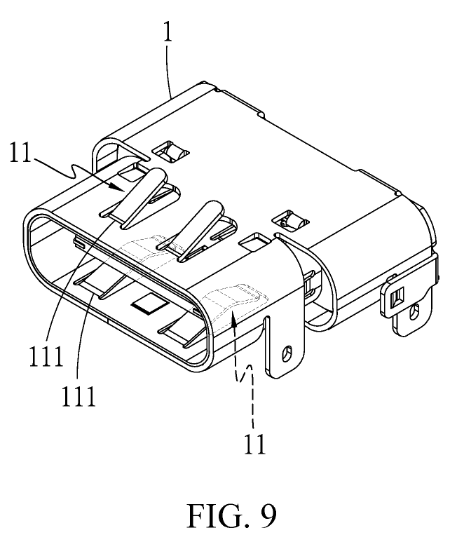

Referring to FIG. 9, which is a schematic view showing implementation of a fifth preferred embodiment of the present invention, the drawing clearly shows that in the instant embodiment, the external contact elements 11 are respectively arranged on the upper side and the lower side of the shielding housing 1, and with respect to the structural arrangement, the elastic portions 111 of the external contact elements 11 on the upper side are formed by extending toward outside of the shielding housing 1, while the elastic portions 111 of the external contact elements 11 on the lower side are formed by extending toward inside of the shielding housing 1. In other words, the present invention provides the external contact elements 11 on both the upper side and the lower side of the shielding housing 1 to increase more noise draining paths and achieve a better performance. Of course, the external contact elements 11 can be alternatively arranged on the edge of the open side of the shielding housing 1 and the lower side thereof, and no constraint is imposed on variability of arrangement.

I claim:

1. An electrical connector, comprising:
a shielding housing, which comprises at least one external contact element formed on at least one side thereof for contact engagement with an electronic component that is located outside of the shielding housing and exhibits an electrical conducting property, wherein the external contact element comprises an elastic portion extending from the shielding housing, a base portion formed on an end of the elastic portion in an extension direction, and a contact portion formed on the base portion in the extension direction;
an insulation plastic body assembly, which is received in the shielding housing and comprises a tongue portion, wherein an insertion space is defined between a circumference of the tongue portion and an inside wall of the shielding housing for receiving insertion of a male connector therein; and
a transmission conductor group, which is combined with the insulation plastic body assembly and complies with USB Type C transmission protocol or USB Type A transmission protocol, and comprises a contact section group arranged on the tongue portion, a base section group formed on and extending from one end of the contact section group, and a soldering section group formed on and extending from one end of the base section group that is opposite to the contact section group, wherein the soldering section group is arranged as a single row.

2. The electrical connector according to claim 1, wherein the elastic portion is formed by extending toward outside of the shielding housing.

3. The electrical connector according to claim 2, wherein the elastic portion is adjacent to an open side of the shielding housing.

4. The electrical connector according to claim 2, wherein the contact portion comprises a first elastic curved portion connected to the base portion, an inclined wall portion formed on one end of the first elastic curved portion in the extension direction, a second elastic curved portion formed on one side of the inclined wall portion that is opposite to the first elastic curved portion, and an engaging portion formed on one side of the second elastic curved portion that is opposite to the inclined wall portion.

5. The electrical connector according to claim 4, wherein the elastic portion is formed by curving in a longitudinal direction and extending from an edge of the open side of the shielding housing.

6. The electrical connector according to claim 1, wherein the elastic portion is formed by extending toward inside of the shielding housing, and an engaging and supporting portion is arranged between the base portion and the contact portion for contact and engagement with a male connector, so that the male connector contacting and engaging the engaging and supporting portion makes the elastic portion deformed to bring the contact portion into contact engagement with the electronic component.

7. The electrical connector according to claim 6, wherein the base portion is formed by extending, in an oblique way, away from the open side of the shielding housing.

8. The electrical connector according to claim 1, wherein the soldering section group comprises at least 16 soldering pins.

9. The electrical connector according to claim 1, wherein the electronic component comprises one of an equipment metal enclosure, a conductive aluminum foil, a copper foil, a polyester film, conductive foam, a metal baffle, a metal shielding, and a conductor area of a circuit board.
